(19) United States
(12) Patent Application Publication
(10) Pub. No.: US 2025/0180907 A1
(43) Pub. Date: Jun. 5, 2025

(54) VIRTUAL-IMAGE DISPLAY DEVICE

(71) Applicant: SEIKO EPSON CORPORATION, Tokyo (JP)

(72) Inventor: Takashi TAKEDA, SUWA-SHI (JP)

(73) Assignee: SEIKO EPSON CORPORATION, Tokyo (JP)

(21) Appl. No.: 18/963,502

(22) Filed: Nov. 28, 2024

(30) Foreign Application Priority Data
Nov. 30, 2023 (JP) 2023-202331

(51) Int. Cl. G02B 27/01; G02B 27/28; G02F 1/137

(52) U.S. Cl. CPC G02B 27/0172; G02B 27/283; G02B 2027/0178; G02F 1/13756; G02F 2203/01

(57) ABSTRACT

A virtual-image display device includes: a light-guiding member configured to cause illumination light from a light source to propagate; a scattering member included in the light-guiding member and including a transmitting region and a scattering region; a transmissive-type liquid crystal panel; a switching half-wave plate configured to switch a polarization direction of incident light into a first direction and a second direction; and a polarizing lens having refractive power that causes polarized light having the first direction to be imaged as a virtual image and configured to cause polarized light having the second direction to pass through, and the switching half-wave plate causes image light to enter the polarizing lens as the polarized light having the first direction when in the displaying state, and causes outside light to enter the polarizing lens as the polarized light having the second direction when in the non-displaying state.

The present application is based on, and claims priority from JP Application Serial Number 2023-202331, filed on Nov. 30, 2023, the disclosure of which is hereby incorporated by reference herein in its entirety.

### BACKGROUND

### 1. Technical Field

The present disclosure relates to a virtual-image display device that makes it possible to observe a virtual image, and in particular, relates to a see-through type virtual-image display device that makes it possible to visually recognize the outside-world image.

### 2. Related Art

A see-through type virtual-image display device that makes it possible to visually recognize the outside world is known (WO 2016/056298). The virtual-image display device includes: a liquid crystal panel including an image display region and a transparent display region formed so as to surround the image display region; and a light-guiding plate configured to guide backlight that enters an end portion from a light source. The light-guiding plate includes a light emission region configured to emit the backlight to the image display region of the liquid crystal panel, and also includes a light transmitting region that transmits the ambient light. This virtual-image display device is configured such that the ambient light reaches the observer from the light transmitting region of the light-guiding plate and the transparent display region, and in a period in which the backlight is not emitted to the image display region, the ambient light passes through the light emission region of the light-guiding plate and the image display region of the liquid crystal panel, and reaches the observer. Such a configuration makes it possible to achieve see-through display in which the image light and the ambient light are superimposed on each other.

In the device described above, processing is performed in the light emission region of the light-guiding plate such that dots are formed or a scattering material is applied, and the ambient light that passes through the image display region of the liquid crystal panel passes through the processed light emission region. Thus, see-through transmittance deteriorates at or around the center of the visual field corresponding to the image display region. In order to achieve the see-through display at or around the center of the visual field with high see-through transmittance, it is necessary to additionally provide an optical system or the like having high see-through transmittance, which leads to an increase in the size of the device.

### SUMMARY

A virtual-image display device according to one aspect of the present disclosure includes, in an order from an outside world, a light-guiding member configured to cause illumination light from a light source to propagate, a scattering member included in the light-guiding member and including a transmitting region and a scattering region, a transmissive-type liquid crystal panel configured to turn into a displaying state and a non-display state, a switching half-wave plate configured to switch a polarization direction of incident light into a first direction and a second direction, the first direction and the second direction intersecting each other, and a polarizing lens having refractive power that causes polarized light having the first direction to be imaged as a virtual image and configured to transmit polarized light having the second direction, in which the transmitting region is disposed at a position that is opposed to one of a pixel and a sub-pixel of the transmissive-type liquid crystal panel, and the switching half-wave plate causes image light to enter the polarizing lens as the polarized light having the first direction when in the displaying state, and causes outside light to enter the polarizing lens as the polarized light having the second direction when in the non-displaying state.

### BRIEF DESCRIPTION OF THE DRAWINGS

FIG. 1 is a perspective view illustrating the external appearance used to describe a state where a virtual-image display device according to a first embodiment is mounted.

FIG. 2 is a schematic perspective view used to describe the optical structure of the virtual-image display device.

FIG. 3 is an enlarged cross-sectional side view used to describe the optical structure of the virtual-image display device.

FIG. 4 is a schematic plan view used to describe a scattering member.

FIG. 5 is a diagram used to describe a state of light passing through a display optical system.

FIG. 6 is a chart used to describe an operation of the virtual-image display device.

FIG. 7 is an enlarged cross-sectional side view used to describe a virtual-image display device according to a second embodiment.

FIG. 8 is a diagram used to describe a state of light passing through the display optical system.

FIG. 9 is an enlarged cross-sectional side view used to describe a virtual-image display device according to a third embodiment.

FIG. 10 is a diagram used to describe a state of light passing through the display optical system.

FIG. 11 is a chart used to describe an operation of the virtual-image display device.

FIG. 12 is an enlarged cross-sectional side view used to describe a virtual-image display device according to a fourth embodiment.

FIG. 13 is an enlarged cross-sectional side view used to describe the virtual-image display device according to the fourth embodiment.

FIG. 14 is a diagram used to describe a pixel structure.

FIG. 15 is a chart used to describe an operation of the virtual-image display device.

### DESCRIPTION OF EMBODIMENTS

### First Embodiment

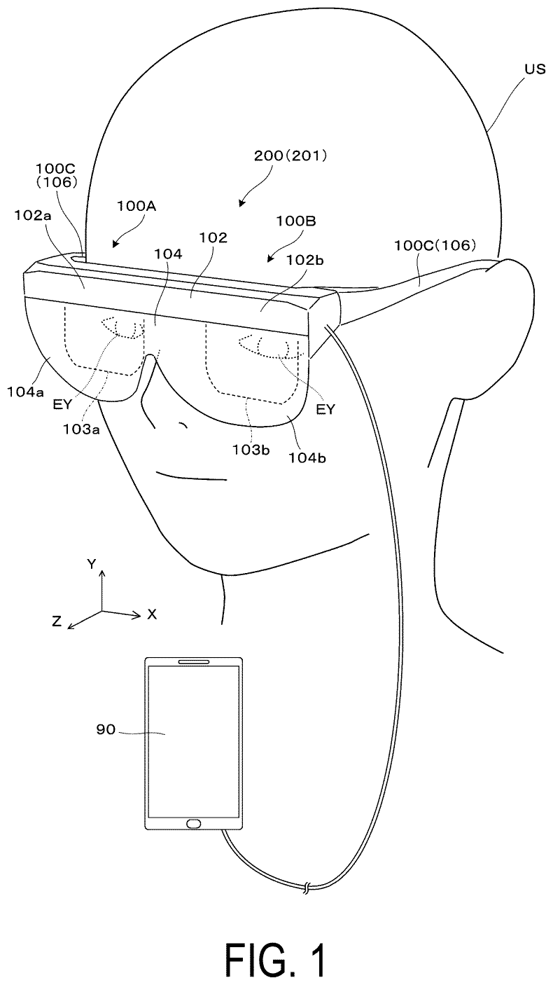

Below, a virtual-image display device according to a first embodiment of the present disclosure will be described with reference to FIGS. 1 to 6.

FIG. 1 is a perspective view used to describe a state where a head-mounted display, that is, a head-mounted display device 200 is mounted. The head-mounted display device (hereinafter, also referred to as an HMD) 200 is a binocular-type display device 201, and is configured to cause an observer or wearer US who mounts this device to recognize an image as a virtual image. In FIG. 1 and the like, X, Y, and Z represent a rectangular coordinate system. The +X direction corresponds to a lateral direction in which both eyes EY of the observer or the wearer US, who wears the HMD 200, are arranged. The +Y direction corresponds to the upward direction perpendicular to the lateral direction from the viewpoint of the wearer US in which both eyes EY are arranged. The +Z direction corresponds to the forward direction or the front side direction from the viewpoint of the wearer US. The +Y direction is parallel to the vertical axis or the vertical direction.

The HMD 200 includes a first virtual-image display device 100A for a right eye, a second virtual-image display device 100B for a left eye, a pair of temples 100C that support the virtual-image display devices 100A and 100B, and a user terminal 90 serving as an information terminal. The first virtual-image display device 100A includes a first display driving unit 102a disposed at an upper part, a first display optical system 103a that covers the front of the eye, and a light transmitting cover 104a that covers the first display optical system 103a at the outside-world side or the front side. The second virtual-image display device 100B includes a second display driving unit 102b disposed at an upper part, a second display optical system 103b that covers the front of the eye, and a light transmitting cover 104b that covers the second display optical system 103b at the outside-world side or the front side. The HMD 200 in which the first virtual-image display device 100A and the second virtual-image display device 100B are combined together is also a virtual-image display device in a broader sense. The pair of temples 100C function as a mounting member or a supporting unit 106 that is worn on the head of the wearer US, and support the upper end sides of the pair of display optical systems 103a and 103b and the upper end sides of the pair of light transmitting covers 104a and 104b via the display driving units 102a and 102b integrated in exterior. A combination of the pair of display driving units 102a and 102b is referred to as a driving device 102. A combination of the pair of light transmitting covers 104a and 104b is referred to as a shade 104.

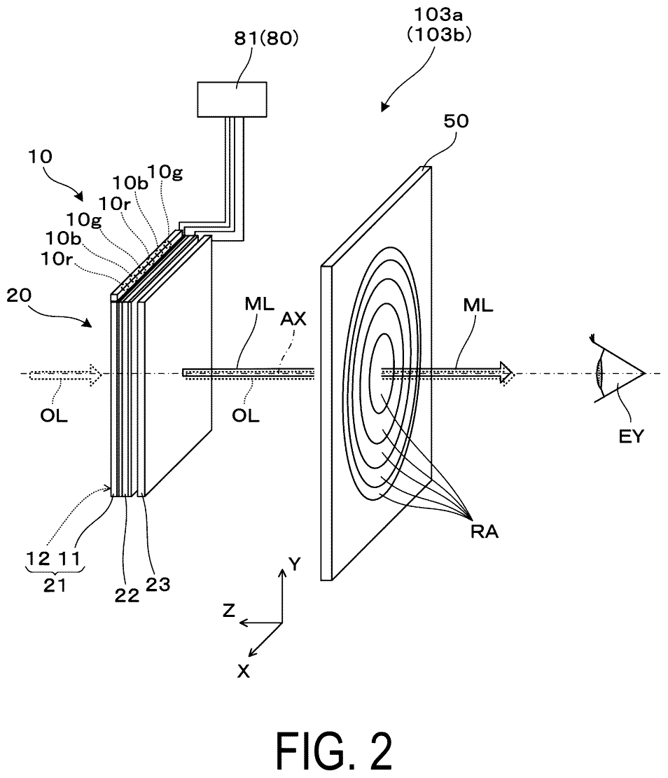

FIG. 2 is a perspective view used to describe the structure of the first display optical system 103a. The first display optical system 103a includes a light source device 10 configured to generate light of three colors as illumination light in a time-division manner, a plate-shaped composite display member 20 configured to form a two-dimensional image and output image light ML, and a polarizing lens 50 functioning as a lens for the image light ML. The light source 10 also constitutes a portion of the first display driving unit 102a illustrated in FIG. 1, and is disposed at or above the upper side of a light-guiding member 21, which will be described later, of the composite display member 20 so as to supply illumination light from the upper end side to the light-guiding member 21. The light source 10 and the composite display member 20 are driven and operated by a driving circuit 81 of a control device 80 embedded in the first display driving unit 102a, thereby achieving observation of the virtual image made of the image light ML and see-through view of the outside world at the same time. In other words, the driving circuit 81 operates a light source 10, a transmissive-type liquid crystal panel 22, and a switching half-wave plate 23 in a synchronized manner. The composite display member 20 and the polarizing lens 50 are disposed so as to be spaced apart from each other in a direction of the optical axis AX. In the first display optical system 103a, the distance between the eye EY and the polarizing lens 50 falls, for example, in a range of approximately 10 mm to 20 mm. In addition, the distance between the composite display member 20 and the polarizing lens 50 falls, for example, in a range of approximately 3 mm to 25 mm.

The light source 10 includes an R light-emitting element 10r configured to generate light of red, a G light-emitting element 10g configured to generate light of green, and a B light-emitting element 10b configured to generate light of blue. The R light-emitting element 10r, the G light-emitting element 10g, and the B light-emitting element 10b are self light-emitting elements, and may be organic light-emitting diodes (OLED), or a light emitting diode such as a micro-light emitting diode (μLED) made of inorganic material. The R light-emitting element 10r, the G light-emitting element 10g, and the B light-emitting element 10b are not limited to those incorporated alone. In other words, the light source 10 is configured by combining one or a plurality of R light-emitting elements 10r, one or a plurality of G light-emitting elements 10g, and one or a plurality of B light-emitting elements 10b. A multiplexer/demultiplexer including a beam splitter used to facilitate diffusion of illumination light can be incorporated between the light source 10 and the light-guiding member 21 of the composite display member 20.

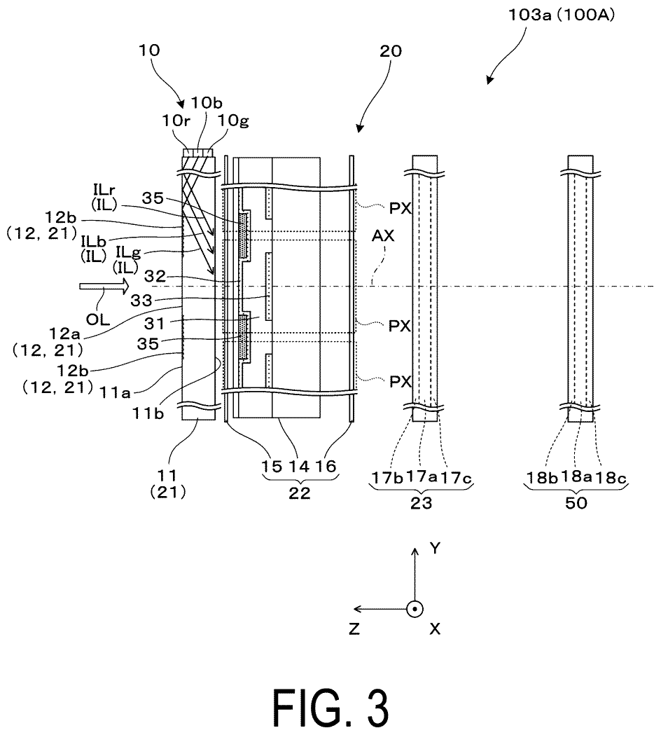

The composite display member 20 is a plate-shape member extending along the XY plane perpendicular to the optical axis AX, and includes the light-guiding member 21, a transmissive-type liquid crystal panel 22, and a switching half-wave plate 23, in the order from the outside world. The composite display member 20 is a plate-shape member as a whole in which the light-guiding member 21, the transmissive-type liquid crystal panel 22, and the switching half-wave plate 23 are stacked to each other, and has a structure integrated by a frame body (not illustrated). Here, the light-guiding member 21, the transmissive-type liquid crystal panel 22, and the switching half-wave plate 23 are fixed to each other in a state where they are disposed close to each other with a predetermined interval being provided between them. Note that the transmissive-type liquid crystal panel 22 includes a plurality of pixels PX (see FIG. 3) arrayed in a matrix manner along the XY plane.

The polarizing lens 50 is disposed at the face side of the composite display member 20, that is, at the −Z side to cover the front of the eye. More specifically, the polarizing lens 50 is opposed to the switching half-wave plate 23 in the composite display member 20, and is disposed at an opposite side from the transmissive-type liquid crystal panel 22. The polarizing lens 50 is a plate-shaped member extending along the XY plane. The polarizing lens 50 operates differently according to the polarization direction of the incident light. The polarizing lens 50 functions as a lens for the image light ML outputted from the composite display member 20. That is, the polarizing lens 50 comprehensively causes a plurality of pixels that constitute the transmissive-type liquid crystal panel 22 to form an image. This enables the image formed on the transmissive-type liquid crystal panel 22 to be observed as a virtual image. In addition, the polarizing lens 50 functions as a parallel flat plate for the outside light OL that passed through the composite display member 20. Specifically, the polarizing lens 50 is a liquid crystal lens, and includes a plurality of circular-shaped ring zone sections RA having different refractive-index states. The group of ring zone sections RA is disposed coaxially so as to be symmetrical around the optical axis AX. In the group of the ring zone sections RA, a ring zone section RA at a periphery away from the optical axis AX has a width in the radial direction with the optical axis Ax being the center, and this width is narrower than that of a ring zone section RA at the center where the optical axis AX passes through. That is, the width of the ring zone section RA in the radial direction reduces toward the periphery.

The second display optical system 103b is optically the same as the first display optical system 103a, or is obtained by inverting the first display optical system 103a horizontally. Thus, detail description thereof will not be given.

With reference to FIG. 3, the light source 10 generates illumination lights ILr, ILg, ILb of three colors in a time-division manner as the illumination light IL, and supplies the illumination lights ILr, ILg, ILb of three colors to the light-guiding member 21 of the composite display member 20. The illumination lights IL of three colors are selected so as to produce white light when they are superimposed on each other.

The light-guiding member 21 is provided such that a light-guiding plate 11 is accompanied by a scattering member 12. In the present embodiment, the scattering member 12 is obtained by processing the front surface of the light-guiding plate 11, and is provided integrally with the light-guiding plate 11. The illumination lights ILr, ILg, ILb from the light source 10 are combined into the light-guiding plate 11 from the upper end of the light-guiding plate 11. The light-guiding plate 11 propagates downward the illumination light ILr, ILg, ILb entering from the light source 10. In addition, the light-guiding plate 11 transmits the outside light OL, and transmits it. The light-guiding plate 11 has a thickness, for example, of 0.5 mm. The light-guiding plate 11 is made of a plastic or glass or the like having optical transparency.

The light-guiding plate 11 includes a flat plate having optical transparency, and includes a pair of flat surfaces 11a and 11b. The scattering member 12 is provided at the flat surface 11a of the light-guiding plate 11 that is disposed at the front side or the outside-world side. In other words, the scattering member 12 is disposed at the flat surface 11a of the light-guiding plate 11 that is at the opposite side from the transmissive-type liquid crystal panel 22. By providing the scattering member 12 at the flat surface 11a at the outside-world side of the light-guiding plate 11, it is possible to make the output angle of the scattering light gentle, which makes it easy to control the scattering angle while facilitating the fabrication of the scattering member 12.

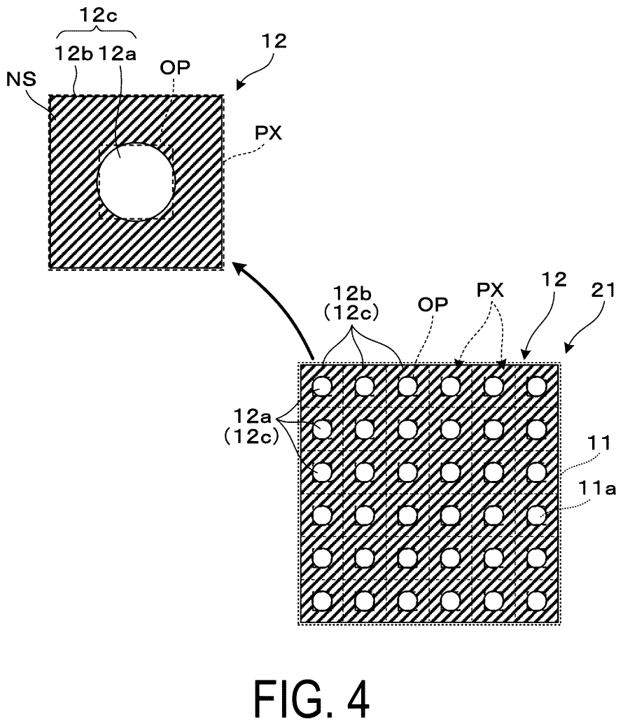

FIG. 4 is a schematic plan view used to describe the scattering member 12. FIG. 4 illustrates the scattering member 12 corresponding to the pixel PX of the transmissive-type liquid crystal panel 22 (see FIG. 3). The scattering member 12 is included in the light-guiding member 21 including the light-guiding plate 11. The scattering member 12 includes a transmitting region 12a, and a scattering region 12b disposed around the transmitting region 12a. The light-guiding member 21 as a whole is configured such that a plurality of repeating sections 12c, each of which is comprised of a pair of the transmitting region 12a and the scattering region 12b, are arranged in a two-dimensional manner as the scattering member 12. In the present embodiment, the scattering member 12 represents a collective body made of one repeating section 12c or a plurality of repeating sections 12c. In plan view, the repeating section 12c has a quadrilateral contour. However, the shape thereof can be changed on an as-necessary basis. In addition, a space may be provided between adjacent repeating sections 12c. The repeating section 12c may be disposed on a pixel PX basis or may be disposed on a sub-pixel basis. In each of the repeating sections 12c, the arrangement of or the area of the transmitting region 12a and the scattering region 12b may be the same or may be different.

The transmitting region 12a transmits the outside light OL. The scattering region 12b scatters the illumination light IL (ILr, ILg, ILb) and emits it to the outside of the light-guiding plate 11. With this configuration, the scattering member 12 generates a transparent state in which the outside light OL is transmitted by using the transmitting region 12a, and also generates a scattering state in which the illumination light IL is outputted to the outside of the light-guiding plate 11 by using the scattering region 12b. In other words, the scattering member 12 is able to create the scattering state and the transparent state at the same time, and also is able to separate the illumination light IL and the outside light OL to output them. Switching of display between the image light ML formed of the illumination light IL and the outside light OL is performed by turning on and off the switching half-wave plate 23.

The transmitting region 12a is disposed at a position that is opposed to the pixel PX of the transmissive-type liquid crystal panel 22. That is, the transmitting region 12a corresponds to an opening OP (pixel electrode 33) of the transmissive-type liquid crystal panel 22. In the present embodiment, the transmitting region 12a is a flat surface 11a of the light-guiding plate 11, and includes a flat and smooth surface. In plan view, the transmitting region 12a has a contour with a circular shape, an oval shape, a quadrilateral contour, a polygonal shape, or the like, for example.

In the repeating section 12c, the scattering region 12b is partially disposed on the light-guiding plate 11 for each of the pixels PX or each of the sub-pixels. The scattering region 12b is disposed so as to surround the transmitting region 12a. Specifically, the scattering region 12b is disposed around the transmitting region 12a, and is disposed at a position corresponding to a black matrix 35 of the transmissive-type liquid crystal panel 22. The shape of the scattering region 12b is determined according to the contour of the repeating section 12c or the transmitting region 12a. In the example illustrated in the drawing, the scattering region 12b externally has a quadrilateral shape in plan view, and has a shape in which the center portion is taken out in a circular shape. Note that, when the contour of the transmitting region 12a has a quadrilateral shape, it is possible that the scattering region 12b has a shape close to the black matrix 35. It may be possible to employ a configuration in which the repeating section 12c does not include the transmitting region 12a, that is, the configuration may partially include the whole of the repeating section 12c being the scattering region 12b.

When priority is given to the image light ML, the scattering member 12 is configured such that the area of the transmitting region 12a is smaller than the size of the opening OP. In addition, when priority is given to the outside light OL, the scattering member 12 is configured such that the area of the transmitting region 12a is increased to have substantially the same size as the opening OP, for example.

The scattering region 12b has a nano-structure NS. The illumination light IL that is scattering light reflected on the scattering region 12b is outputted by the nano-structure NS in a direction of the opening OP (pixel electrode 33) of the transmissive-type liquid crystal panel 22. The scattering state at the scattering region 12b may include scattering in a lambert manner or may include scattering having directivity. The nano-structure NS is able to control the scattering direction and the scattering angle of the illumination light IL such that more light is diffracted to a predetermined location. As the illumination light IL is gathered at the opening OP of the transmissive-type liquid crystal panel 22 as the scattering light having directivity, it is possible to increase the usage efficiency of light.

As with the light-guiding plate 11 serving as a base member, the scattering member 12 is formed of glass or plastic. The scattering member 12 has the same refractive index as the light-guiding plate 11. The nano-structure NS is formed through nano-imprint lithography or photolithography or the like.

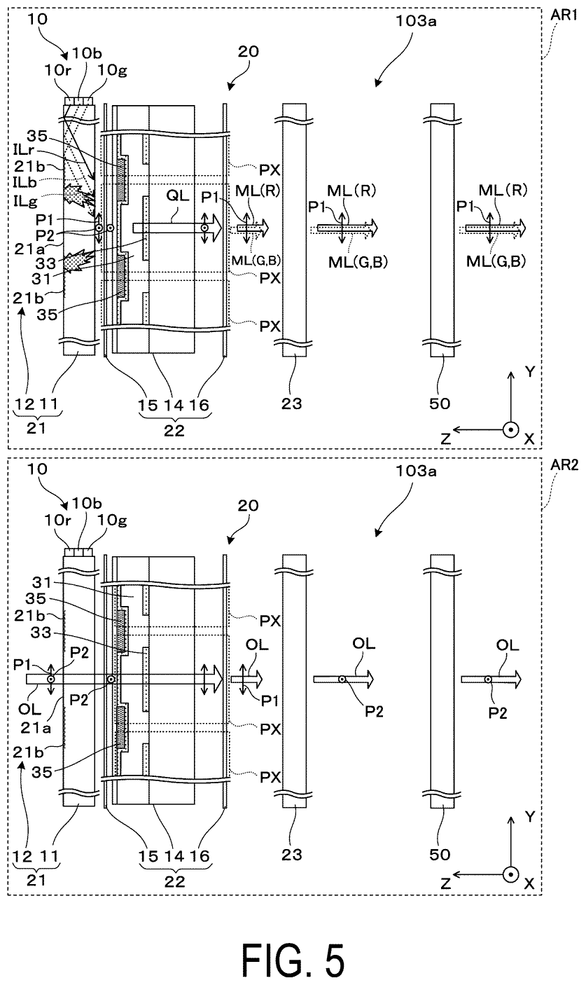

Returning to FIG. 3, the transmissive-type liquid crystal panel 22 is opposed to the light-guiding plate 11, and is disposed at a face side, that is, at the −Z side. The transmissive-type liquid crystal panel 22 includes a liquid-crystal modulation member 14, and a pair of polarizing plates 15 and 16 between which the liquid-crystal modulation member 14 is interposed. In this case, the transmissive-type liquid crystal panel 22 or the liquid-crystal modulation member 14 is a modulation element comprised, for example, of an in-plane switching (IPS) type liquid crystal or the like, and operates pixel PX by pixel PX. The pixel PX does not includes a filter, and is colorless. In the transmissive-type liquid crystal panel 22, the size of the region where the pixel PX is formed falls in a range of approximately 1 to 2 inches, and the number of pixels falls in a range of approximately 2 k to 4 k. The liquid-crystal modulation member 14 does not rotate the polarization direction of incident light when no electric field is applied, and rotates the polarization direction of incident light when an electric field is applied. In this case, the pair of polarizing plates 15 and 16 are disposed in a direction intersecting the polarization direction, more specifically, in a direction in which the polarization direction is perpendicular. In other words, the image light ML or the outside light OL that has passed through the transmissive-type liquid crystal panel 22 and has been outputted from the polarizing plate 16 is first polarized light P1 of which polarization direction is vertical and is a first direction (see FIG. 5). The transmissive-type liquid crystal panel 22 is able to switch ON and OFF pixel PX by pixel PX in accordance with a drive signal from the driving circuit 81 (see FIG. 2, and is able to cause incident light to partially pass through with any given gray-scale in the middle of between ON and OFF. For this reason, the liquid-crystal modulation member 14 not only includes a liquid crystal layer 31, a common electrode 32, a pixel electrode 33, and a black matrix 35 but also includes a scanning line, a signal line, a switching element, and the like, although illustration is not given.

Note that the transmissive-type liquid crystal panel 22 or the liquid-crystal modulation member 14 rotates the polarization direction of incident light when no electric field is applied, and does not rotate the polarization direction of incident light when an electric field is applied. In this case, the pair of polarizing plates 15 and 16 are disposed such that polarization directions are parallel to each other.

The switching half-wave plate 23 is opposed to the transmissive-type liquid crystal panel 22, and is disposed at an opposite side from the light-guiding plate 11. The switching half-wave plate 23 is a unit configured to perform switching-type operation in accordance with a drive signal from the driving circuit 81 (see FIG. 2), and switches the polarization direction of incident light between the first direction and the second direction depending on an alignment direction of liquid crystal to transmit the incident light. The first direction and the second direction intersect each other. The switching half-wave plate 23 includes a liquid crystal layer 17a interposed between a pair of base members 17b and 17c with a transparent electrode layer (not illustrated) being interposed between them. The liquid crystal layer 17a is, for example, an in-plane switching (IPS) type liquid crystal or the like, and does not rotate the polarization direction of incident light when no electric field is applied whereas rotating the polarization direction of incident light when an electric field is applied. The switching half-wave plate 23 is able to switch between ON and OFF over the entire surface rather than on a pixel basis. When the switching half-wave plate 23 is in the OFF state, the switching half-wave plate 23 entirely functions as a transparent flat plate, and transmits the image light ML (in other words, the first polarized light P1 of which polarization direction is vertical and is the first direction, that is, the +Y direction) while its polarization direction is maintained (see a first region AR1 in FIG. 5). On the other hand, when the switching half-wave plate 23 is in the ON state, the switching half-wave plate 23 entirely functions as a half wave plate having the main axis disposed between the X direction and the Y direction, and rotates the polarization direction of the outside light OL (in other words, the first polarized light P1 of which polarization direction is vertical and is the first direction) by 90° to output it as a second polarized light P2 of which polarization direction is horizontal and is a second direction (see a second region AR2 in FIG. 5).

The polarizing lens 50 disposed at the face side of the switching half-wave plate 23 includes a liquid crystal layer 18a interposed between a pair of base members 18b and 18c with a transparent electrode layer (not illustrated) being interposed between them. As described above, the liquid crystal layer 18a includes a number of circular-shaped ring zone sections RA (see FIG. 2) having different refractive-index states along the XY plane and around the optical axis AX. For the first polarized light P1 of which polarization direction is the vertical first direction parallel to the paper surface, that is, +Y direction, in other words, for the image light ML, the liquid crystal layer 18a functions as a lens having positive power such that the refractive index gradually reduces toward the ring zone section RA at the outer edge from the ring zone section RA at the center through which the optical axis AX passes. The position of the focal point of the polarizing lens 50 is a position of the opening OP (pixel electrode 33) of the transmissive-type liquid crystal panel 22. In addition, for the second polarized light P2 of which polarization direction is the horizontal second direction perpendicular to the paper surface, that is, +X direction, in other words, for the outside light OL, the liquid crystal layer 18a functions as a parallel flat plate in which the refractive indexes of individual ring zone sections RA are uniform. Thus, the polarizing lens 50 has refractive power that causes the first polarized light P1 having the first direction to be imaged as a virtual image, and transmits the second polarized light P2 of the second direction.

Below, with reference to FIG. 5, description will be made of a state of light in the first display optical system 103a. In FIG. 5, the first region AR1 indicates a case where the first display optical system 103a is in the image observation period and the transmissive-type liquid crystal panel 22 is in the displaying state. In addition, the second region AR2 indicates a case where the first display optical system 103a is in the outside-light observation period, and the transmissive-type liquid crystal panel 22 is in the non-display state. In the transmissive-type liquid crystal panel 22, the displaying state represents a state where the illumination light IL that has passed through the scattering region 12b of the scattering member 12 is caused to enter to form the image light ML. In addition, the non-display state represents a state where the outside light OL that has passed through the transmitting region 12a of the scattering member 12 is transmitted.

In a first stage of the image observation period, of the light-emitting elements 10r, 10g, and 10b of the light source 10, the R light-emitting element 10r emits light to supply the light-guiding member 21 with illumination light ILr that is red light, for example. The illumination light ILr is guided within the light-guiding plate 11, and turns into the scattering state in the scattering region 12b of the scattering member 12. The illumination light ILr passes through the first polarizing plate 15 of the transmissive-type liquid crystal panel 22, and illuminates the liquid-crystal modulation member 14 as the second polarized light P2 that is lateral polarized light. In other words, each of the colorless pixels PX that constitute the transmissive-type liquid crystal panel 22 is illuminated. The image light QL that has passed through the liquid-crystal modulation member 14 is light obtained by rotating the polarization surface of the illumination light ILr in accordance with a drive signal, and only the first polarized light P1 that has passed through the second polarizing plate 16 and is vertical polarized light is outputted as the image light ML(R). The image light ML(R) outputted from each of the pixels PX of the transmissive-type liquid crystal panel 22 enters the switching half-wave plate 23. At this time, the switching half-wave plate 23 is switched into the OFF state to function as a transparent flat plate, and transmits the image light ML(R) of the first polarized light P1 while its polarization direction is maintained. The image light ML(R) of the first polarized light P1 that has passed through the switching half-wave plate 23 passes through the polarizing lens 50 functioning as a convex lens for the first polarized light P1 to form a virtual image.

In a second stage of the image observation period, the G light-emitting element 10g of the light source 10 emits light instead of the R light-emitting element 10r to supply the light-guiding member 21 with the illumination light ILg that is green light, and the light is outputted toward the side direction from the light-guiding member 21. The image light QL passing through individual pixels PX that constitute the transmissive-type liquid crystal panel 22 or the liquid-crystal modulation member 14 illuminated with the illumination light ILg is light obtained by rotating the polarization surface of the illumination light ILg in accordance with a drive signal. Individual pixels PX of the transmissive-type liquid crystal panel 22 output image light ML(G) that is the first polarized light P1. The switching half-wave plate 23 is maintained to be in the OFF state. The image light ML(G) of the first polarized light P1 that has passed through the switching half-wave plate 23 passes through the polarizing lens 50 functioning as a convex lens for the first polarized light P1 to form a virtual image.

In a third stage of the image observation period, the B light-emitting element 10b of the light source 10 emits light instead of the G light-emitting element 10g, to supply the light-guiding member 21 with the illumination light ILb that is blue light, and the light is outputted toward the side direction from the light-guiding member 21. The image light QL passing through individual pixels PX that constitute the transmissive-type liquid crystal panel 22 or the liquid-crystal modulation member 14 illuminated with the illumination light ILb is light obtained by rotating the polarization surface of the illumination light ILb in accordance with a drive signal. Individual pixels PX of the transmissive-type liquid crystal panel 22 output image light ML(B) that is the first polarized light P1. The switching half-wave plate 23 is maintained to be in the OFF state. The image light ML(B) of the first polarized light P1 that has passed through the switching half-wave plate 23 passes through the polarizing lens 50 functioning as a convex lens for the first polarized light P1 to form a virtual image.

During the image observation period, in other words, when the transmissive-type liquid crystal panel 22 is in the displaying state, the image lights ML(R), ML(G), and ML(B) of three colors are sequentially displayed. The switching half-wave plate 23 causes the first polarized light P1 that is the image light ML from the transmissive-type liquid crystal panel 22 to enter the polarizing lens 50. The wearer US recognizes a color image.

In addition, in an outside-light observation period, the light source 10 is turned into a non-emitting state, that is, into a turning-off state to stop supplying the illumination light IL to the light-guiding member 21. The outside light OL enters the transmitting region 12a of the scattering member 12, and passes through the light-guiding plate 11. Thus, the outside light OL travels straight so as to intersect the light-guiding member 21, and enters the transmissive-type liquid crystal panel 22. At this time, individual pixels PX of the transmissive-type liquid crystal panel 22 operate, for example, in a normally-off manner, and are brought into a maximum transmitting state in accordance with a drive signal. Of the outside light OL entering the pixels PX of the transmissive-type liquid crystal panel 22, the second polarized light P2 travels straight through the transmissive-type liquid crystal panel 22, that is, through the pixels PX to be converted into the first polarized light P1, and enters the switching half-wave plate 23. At this time, the switching half-wave plate 23 is switched into the ON state to function as a half wave plate, and causes the polarization direction of the outside light OL that is the first polarized light P1 to rotate by 90° to output it as the second polarized light P2. In other words, when the transmissive-type liquid crystal panel 22 is in the non-display state, the switching half-wave plate 23 causes the outside light OL that has passed through the transmissive-type liquid crystal panel 22 to enter the polarizing lens 50 as the second polarized light P2. The outside light OL of the second polarized light P2 that has passed through the switching half-wave plate 23 passes through the polarizing lens 50 that functions as a parallel flat plate for the second polarized light P2, and enters the eye EY without receiving any image formation operation by the composite display member 20 or the polarizing lens 50.

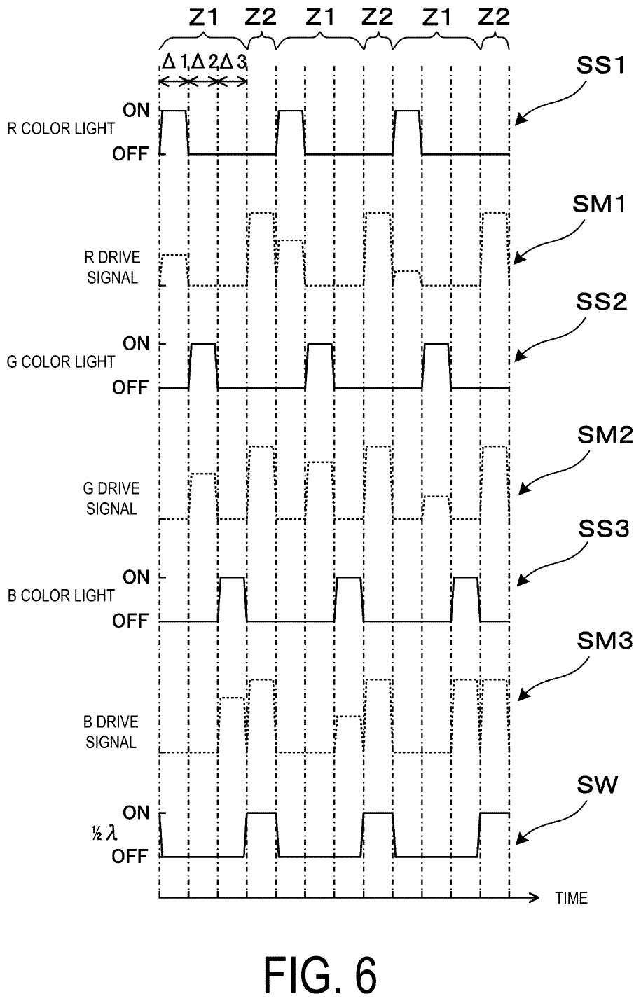

FIG. 6 is a chart used to describe a display operation of the first virtual-image display device 100A. The horizontal axis indicates time. In addition, the chart indicates, from the upper side, a blinking signal SS1 of the R light-emitting element 10r, an R drive signal SM1 for red display supplied to the liquid-crystal modulation member 14, a blinking signal SS2 of the G light-emitting element 10g, a G drive signal SM2 for green display supplied to the liquid-crystal modulation member 14, a blinking signal SS3 of the B light-emitting element 10b, a B drive signal SM3 for blue display supplied to the liquid-crystal modulation member 14, and an ON-OFF signal SW of the switching half-wave plate (½λ) 23. As for operations by the first virtual-image display device 100A, each frame includes a first sub-frame Z1 serving as a sub-frame for observing an image, and a second sub-frame 22 serving as a sub-frame for observing the outside light.

In a red-color display section Al that is the first stage of the first sub-frame Z1 for observing an image, the driving circuit 81 turns on the R light-emitting element 10r, outputs the R drive signal SM1 for red display to each of the pixels PX of the transmissive-type liquid crystal panel 22, and turns the switching half-wave plate 23 into the OFF state. With this operation, the red image light ML (R) enters the eye EY. In addition, with the polarizing lens 50, it is possible to observe a virtual image corresponding to a red pattern formed on the transmissive-type liquid crystal panel 22. In a green-color display section Δ2 that is the second stage of the first sub-frame Z1, the driving circuit 81 turns on the G light-emitting element 10g, outputs the G drive signal SM2 for green display to each of the pixels PX of the transmissive-type liquid crystal panel 22, and maintains the OFF state of the switching half-wave plate 23. With this operation, the green image light ML(G) enters the eye EY. In addition, with the polarizing lens 50, it is possible to observe a virtual image corresponding to a green pattern formed on the transmissive-type liquid crystal panel 22. In a blue-color display section 43 that is the third stage of the first sub-frame Z1, the driving circuit 81 turns on the B light-emitting element 10b, outputs the B drive signal SM3 for blue display to each of the pixels PX of the transmissive-type liquid crystal panel 22, and maintains the OFF state of the switching half-wave plate 23. With this operation, the blue image light ML(B) enters the eye EY. In addition, with the polarizing lens 50, it is possible to observe a virtual image corresponding to a blue pattern formed on the transmissive-type liquid crystal panel 22.

In the first sub-frame Z1, that is, the image observation period described above, the image lights ML(R), ML(G), and ML(B) of three colors are sequentially displayed by the transmissive-type liquid crystal panel 22 that is in the displaying state or the transmitting state, whereby the wearer US recognizes a color image.

In the second sub-frame Z2 for observing the outside world, the driving circuit 81 turns off the light source 10, outputs, for example, a drive signal with the maximum transmissivity to each of the pixels PX of the transmissive-type liquid crystal panel 22, and turns the switching half-wave plate 23 into the ON state. At this time, the transmissive-type liquid crystal panel 22 is in the non-display state and also in the transmitting state. With this operation, the outside light OL that travels straight through the transmissive-type liquid crystal panel 22 and the polarizing lens 50 enters the eye EY, whereby it is possible to observe the outside-world image.

The structure of the first embodiment described above is given merely as an example. For example, the transmissive-type liquid crystal panel 22 does not need to operate in a normally-off manner, and may operate in a normally-on manner. In a case of operation in a normally-on manner, the drive signals SM1, SM2, and SM3 illustrated in FIG. 6 are inverted in terms of the gray-scale, that is, are obtained by inverting the size (high or low) of the applied voltage. The transmissive-type liquid crystal panel 22 is not limited to an IPS-type liquid crystal element, and may be other types of liquid crystal display element such as a TN-type liquid crystal element.

The switching half-wave plate 23 may be configured to rotate the polarization direction of the image light ML by 90° to output it as the second polarized light P2, and transmit the outside light OL as the first polarized light P1 while maintaining the polarization direction thereof as it is. In this case, the polarizing lens 50 has refractive power that transmits the image light ML of the second polarized light P2 to be imaged as a virtual image, and serves as the parallel flat plate to cause the outside light OL of the first polarized light P1 to pass through. Note that the second polarized light P2 that receives an image formation operation by such a polarizing lens 50 can be called first polarized light, and the first polarized light P1 that does not receive any image formation operation by this polarizing lens 50 can be called second polarized light.

The first sub-frame Z1 and the second sub-frame Z2 illustrated in FIG. 6 are given merely as examples. The time width or the time ratio of the sub-frames Z1 and Z2 is adjustable, for example, by the control device 80 in accordance with the environments of the outside world, and can be adjusted by the wearer US through the user terminal 90.

In the first sub-frame Z1, the pixels PX of the transmissive-type liquid crystal panel 22 do not need to be set in the maximum transmitting state. By adjusting the transmittance of the pixels PX, it is possible to adjust the intensity of the transmissivity for the outside light OL as with photochromic sunglasses. At this time, it is possible to adjust the transmittance at local areas of the transmissive-type liquid crystal panel 22, rather than at the entire area.

The virtual-image display device 100A, 100B according to the first embodiment described above includes, in the order from the outside world: the light-guiding member 21 configured to cause the illumination light IL from the light source 10 to propagate; the scattering member 12 included in the light-guiding member 21 and including the transmitting region 12a and the scattering region 12b; the transmissive-type liquid crystal panel 22 configured to turn into the displaying state and the non-display state; the switching half-wave plate 23 configured to switch a polarization direction of incident light into the first direction and the second direction, the first direction and the second direction intersecting each other; and the polarizing lens 50 having refractive power that causes polarized light having the first direction to be imaged as a virtual image and configured to transmit polarized light having the second direction, in which the transmitting region 12a is disposed at a position that is opposed to one of the pixel PX and the sub-pixel of the transmissive-type liquid crystal panel 22, and the switching half-wave plate 23 causes the image light ML to enter the polarizing lens 50 as the polarized light having the first direction when in the displaying state, and causes the outside light OL to enter the polarizing lens 50 as the polarized light having the second direction when in the non-displaying state.

With the virtual-image display device described above, when the transmissive-type liquid crystal panel 22 is in the displaying state, the switching half-wave plate 23 causes the image light ML from the transmissive-type liquid crystal panel 22 to enter the polarizing lens 50 as the first polarized light P1 having the first direction. In addition, when the transmissive-type liquid crystal panel 22 is in the non-displaying state, the switching half-wave plate 23 causes the outside light OL that has passed through the transmissive-type liquid crystal panel 22 to enter the polarizing lens 50 as the second polarized light P2 having the second direction. Thus, it is possible to switch the image light ML and the outside light OL and observe them in parallel. In other words, by utilizing the scattering member 12, it is possible to use the transmissive-type liquid crystal panel 22 to observe the image as well as to observe the outside world, and it is possible to suppress a deterioration in the see-through transmittance while securing the brightness of display.

In the virtual-image display device 100A, 100B according to the first embodiment, the light source 10 switches and generates illumination light of red, illumination light of green, and illumination light of blue, the transmissive-type liquid crystal panel 22 includes a colorless pixel PX, and performs modulation with the pixel PX in accordance with the color of the illumination light generated by the light source 10, and the transmissive-type liquid crystal panel 22 turns the pixel PX into the transmitting state when the light source 10 does not emit light. In this case, during the first sub-frame Z1 that is the sub-frame for observing an image, there are display sections Δ1, Δ2, and Δ3 for individual colors in which the image lights ML(R), ML(G), and ML(B) of red, green, and blue are displayed.

### Second Embodiment

Below, a virtual-image display device or the like according to a second embodiment will be described. Note that the virtual-image display device according to the second embodiment is provided by partially modifying the virtual-image display device according to the first embodiment. Thus, explanation of portions common to the virtual-image display device according to the first embodiment will not be repeated.

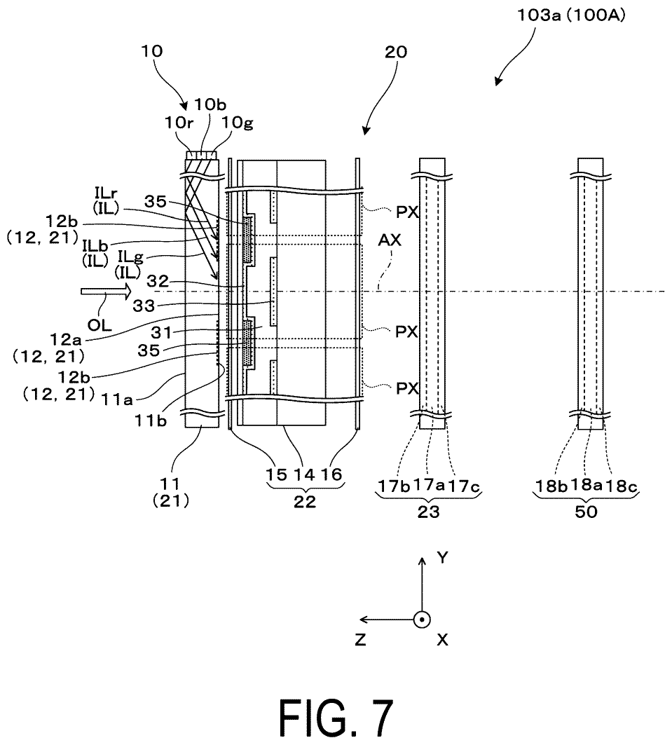

In the first display optical system 103a or the first virtual-image display device 100A illustrated in FIG. 7, the scattering member 12 is disposed at the surface of the light-guiding plate 11 that is opposed to the transmissive-type liquid crystal panel 22, that is, at the flat surface 11b that is at the rear side of the light-guiding plate 11. This makes it possible to concentrate the scattering light on a relatively very small region. The illumination light IL that is scattering light that passes through the scattering region 12b is outputted by the nano-structure NS in a direction of the opening OP (pixel electrode 33) of the transmissive-type liquid crystal panel 22.

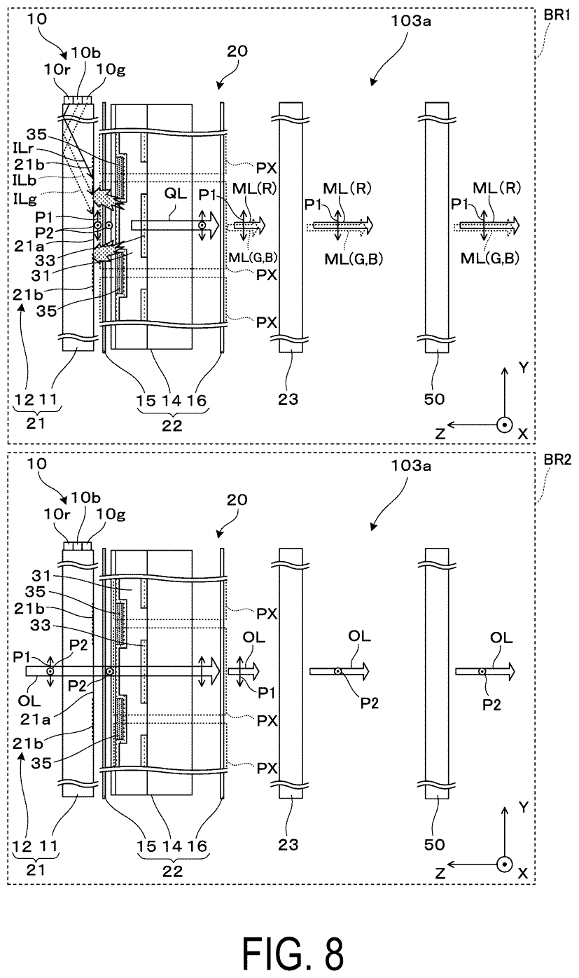

Below, the state of light in the first display optical system 103a will be described with reference to FIG. 8. In FIG. 8, the first region BR1 indicates a case where the first display optical system 103a is in the image observation period and the transmissive-type liquid crystal panel 22 is in the displaying state. In addition, the second region BR2 indicates a case where the first display optical system 103a is in the outside-light observation period, and the transmissive-type liquid crystal panel 22 is in the non-display state.

During the image observation period, in other words, when the transmissive-type liquid crystal panel 22 is in the displaying state, the image lights ML(R), ML(G), and ML(B) of three colors are sequentially displayed. The switching half-wave plate 23 causes the first polarized light P1 that is the image light ML from the transmissive-type liquid crystal panel 22 to enter the polarizing lens 50. The wearer US recognizes a color image.

In addition, in an outside-light observation period, the light source 10 is turned into a non-emitting state, that is, into a turning-off state to stop supplying the illumination light IL to the light-guiding member 21. The outside light OL passes through the light-guiding plate 11, and passes through the transmitting region 12a of the scattering member 12. Thus, the outside light OL travels straight so as to intersect the light-guiding member 21, and enters the transmissive-type liquid crystal panel 22. At this time, individual pixels PX of the transmissive-type liquid crystal panel 22 are brought into a maximum transmitting state, for example, with a normally-on operation. In addition, of the outside light OL entering the pixels PX of the transmissive-type liquid crystal panel 22, the second polarized light P2 travels straight through the transmissive-type liquid crystal panel 22, that is, through the pixels PX to be converted into the first polarized light P1, and enters the switching half-wave plate 23. At this time, the switching half-wave plate 23 in the ON state rotates the polarization direction of the outside light OL of the first polarized light P1 by 90°, and outputs the light as the second polarized light P2. The outside light OL of the second polarized light P2 that has passed through the switching half-wave plate 23 passes through the polarizing lens 50 functioning as a parallel flat plate for the second polarized light P2, and enters the eye EY without receiving any image formation operation by the composite display member 20 and the polarizing lens 50.

### Third Embodiment

Below, a virtual-image display device or the like according to a third embodiment will be described. Note that the virtual-image display device according to the third embodiment is provided by partially modifying the virtual-image display device according to the first embodiment. Thus, explanation of portions common to the virtual-image display device according to the first embodiment will not be repeated.

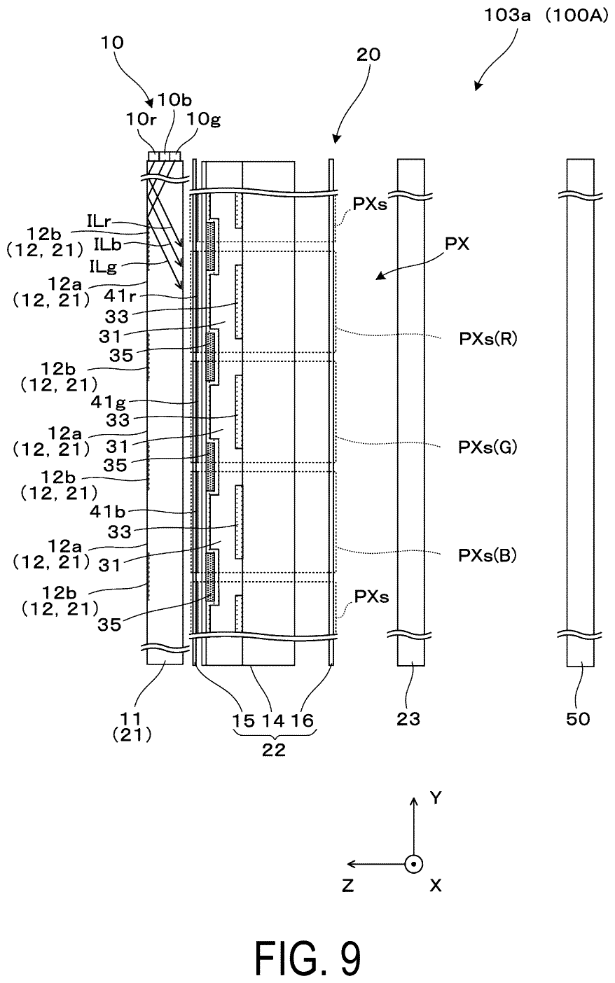

In the first display optical system 103a or the first virtual-image display device 100A illustrated in FIG. 9, the transmissive-type liquid crystal panel 22 includes sub-pixels PXs, specifically, includes three types of sub-pixels PXs(R), PXs(G), and PXs(B). These sub-pixels PXs(R), PXs(G), and PXs(B) are arrayed in a stripe pattern or a Bayer pattern to constitute a pixel PX, although illustration is not given.

In the sub-pixel PXs(R) for red display, a red color filter 41r is disposed at or around the first polarizing plate 15. In the sub-pixel PXs(G) for green display, a green color filter 41g is disposed at or around the first polarizing plate 15. In the sub-pixel PXs(B) for blue display, a blue color filter 41b is disposed at or around the first polarizing plate 15.

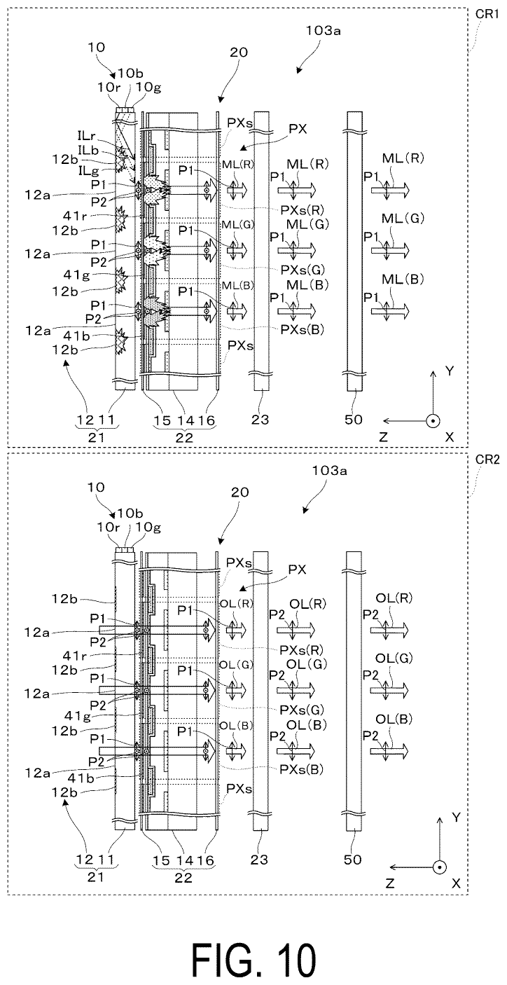

The state of light in the first display optical system 103a will be described with reference to FIG. 10. In FIG. 10, the first region CR1 indicates a case where the first display optical system 103a is in the image observation period and the transmissive-type liquid crystal panel 22 is in the displaying state, and the second region CR2 indicates a case where the first display optical system 103a is in the outside-light observation period, and the transmissive-type liquid crystal panel 22 is in the non-display state.

In the image observation period, by causing all the light-emitting elements 10r, 10g, and 10b that constitute the light source 10 to emit light, the white illumination light ILr, ILg, ILb is supplied to the light-guiding member 21. The illumination light ILr, ILg, ILb is scattered at the scattering region 12b of the scattering member 12, and emitted from the light-guiding member 21. The second polarized light P2 of the illumination light ILr, ILg, ILb passes through the first polarizing plate 15 of the transmissive-type liquid crystal panel 22, and illuminates the sub-pixels PXs(R), PXs(G), and PXs(B) that constitute each of the pixels PX. Thus, the ML(R), the ML(G), and the ML(B) of the first polarized light P1 that have been modulated are outputted in parallel from the transmissive-type liquid crystal panel 22. The image light ML(R), ML(G), ML(B) outputted from each of the sub-pixels PXs(R), PXs(G), PXs(B) of the transmissive-type liquid crystal panel 22 enters the switching half-wave plate 23 that is in the OFF state. The switching half-wave plate 23 transmits the image light ML(R), ML(G), ML(B) of the first polarized light P1 while its polarization direction is maintained as it is. The image light ML(R), ML(G), ML(B) of the first polarized light P1 that has passed through the switching half-wave plate 23 passes through the polarizing lens 50 functioning as a convex lens for the first polarized light P1 to form a virtual image.

In addition, in an outside-light observation period, the light source 10 is turned into a non-emitting state, that is, into a turning-off state to stop supplying the illumination light IL to the light-guiding member 21. The outside light OL enters the transmitting region 12a of the scattering member 12, and passes through the light-guiding plate 11. Thus, the outside light OL travels straight so as to intersect the light-guiding member 21, and enters the transmissive-type liquid crystal panel 22. At this time, the sub-pixels PXs(R), PXs(G), and PXs(B) that constitute each of the pixels PX of the transmissive-type liquid crystal panel 22 are, for example, in the maximum transmitting state. The second polarized light P2 of the outside light OL travels straight through the transmissive-type liquid crystal panel 22, that is, through the sub-pixels PXs(R), PXs(G), and PXs(B) to be converted into the first polarized light P1, and enters the switching half-wave plate 23. The switching half-wave plate 23 in the ON state rotates the polarization direction of the outside light OL of the first polarized light P1 by 90°, and outputs the light as the second polarized light P2. The outside light OL of the second polarized light P2 that has passed through the switching half-wave plate 23 passes through the polarizing lens 50 functioning as a parallel flat plate for the second polarized light P2, and enters the eye EY without receiving any image formation operation by the composite display member 20 and the polarizing lens 50.

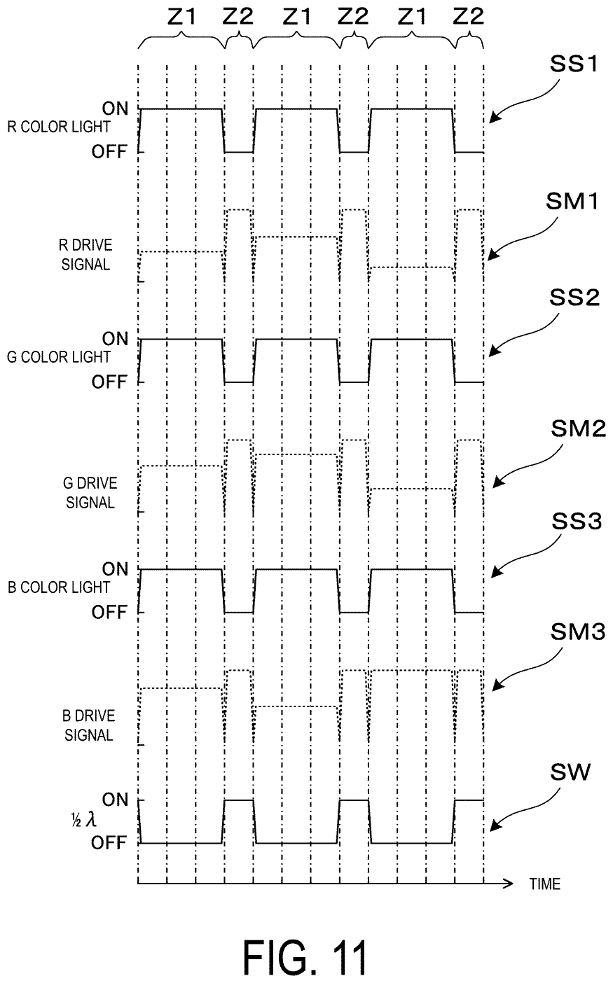

FIG. 11 is a timing chart used to describe the display operation of the first virtual-image display device 100A, and corresponds to the timing chart illustrated in FIG. 6 according to the first embodiment. In this case, the image lights ML(R), ML(G), and ML(B) of three colors are displayed in parallel at the same time, rather than the image lights ML(R), ML(G), and ML(B) of three colors being sequentially displayed. When the first virtual-image display device 100A is in the outside-light observation period and the transmissive-type liquid crystal panel 22 is in the non-display state, the outside light OL passes through the sub-pixels PXs(R), PXs(G), and PXs(B) of the transmissive-type liquid crystal panel 22 in a well-balanced manner. Thus, it is possible to observe the colorless outside-world image.

In the present embodiment, it may also possible to employ a configuration in which the switching half-wave plate 23 rotates the polarization direction of the image light ML by 90° to output the light as the second polarized light P2, and transmits the outside light OL as the first polarized light P1 while its polarization direction is maintained as it is. In addition, the time width or the time ratio of the sub-frames Z1 and Z2 is adjustable, for example, by the control device 80 in accordance with the environments of the outside world.

In the second sub-frame Z2 for observing the outside light, each of the sub-pixels PXs(R), PXs(G), and PXs(B) that constitute the transmissive-type liquid crystal panel 22 does not need to be in the maximum transmitting state, and it is possible to separately adjust the transmittance of each of the sub-pixels PXs(R), PXs(G), and PXs(B).

In addition, as with the scattering member 12 according to the second embodiment, the scattering member 12 according to the present embodiment may be disposed at a surface of the light-guiding plate 11 that is opposed to the transmissive-type liquid crystal panel 22, that is, may be disposed at the flat surface 11b that is at the rear side of the light-guiding plate 11.

In the virtual-image display device 100A, 100B according to the third embodiment, the light source 10 generates white illumination light ILr, ILg, ILb, and the transmissive-type liquid crystal panel 22 includes a sub-pixel PXs(R) for red, a sub-pixel PXs(G) for green, and a sub-pixel PXs(B) for blue to perform modulation with the sub-pixels PXs(R), PXs(G), and PXs(B) for individual colors in accordance with the light emitted by the light source 10, and turns the sub-pixels PXs(R), PXs(G), and PXs(B) for individual colors into the transmitting state when the light source 10 does not emit light. In this case, in the first sub-frame Z1 that is the sub-frame for observing an image, it is possible to display the red image light ML, the green image light ML, and the blue image light ML at the same time.

### Fourth Embodiment

Below, a virtual-image display device or the like according to a fourth embodiment will be described. Note that the virtual image display device according to the fourth embodiment is obtained by partially modifying the virtual image display devices according to the first and third embodiments, and description of parts in common with those of the virtual image display devices according to the first embodiment and the like will not be repeated.

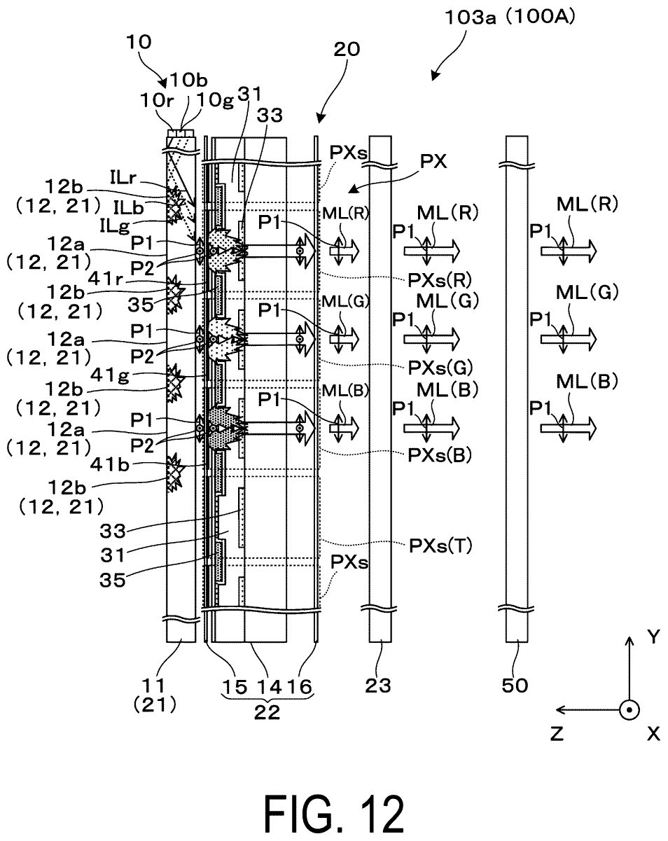

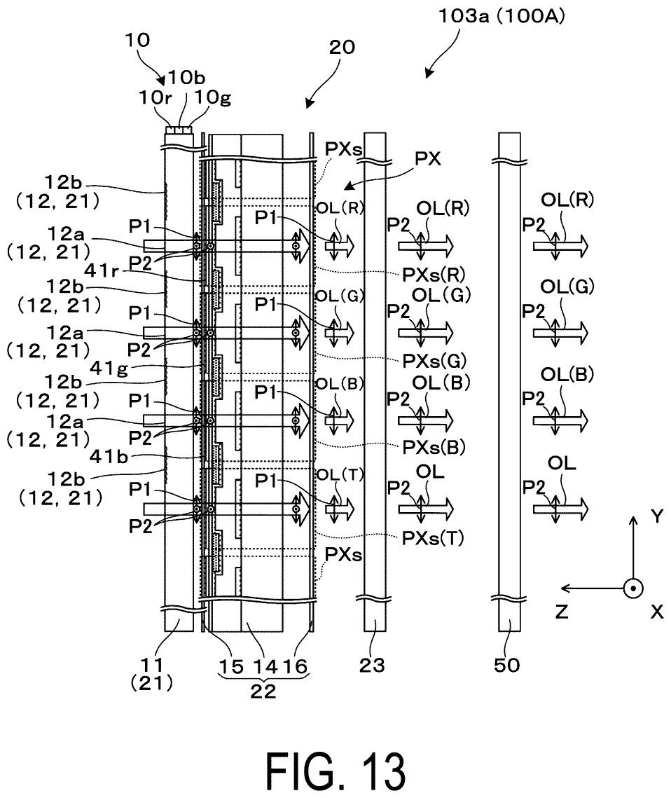

In the first display optical system 103a or the first virtual-image display device 100A illustrated in FIGS. 12 and 13, the transmissive-type liquid crystal panel 22 includes the sub-pixels PXs, specifically, four types of sub-pixels PXs(R), PXs(G), PXs(B), and PXs(T). Three types of sub-pixels PXs(R), PXs(G), and PXs(B) each include a color filter 41r, 41g, 41b, and are used for the image light ML. The remaining one type of sub-pixel PXs(T) does not include any color filter, and is used for the outside light OL.

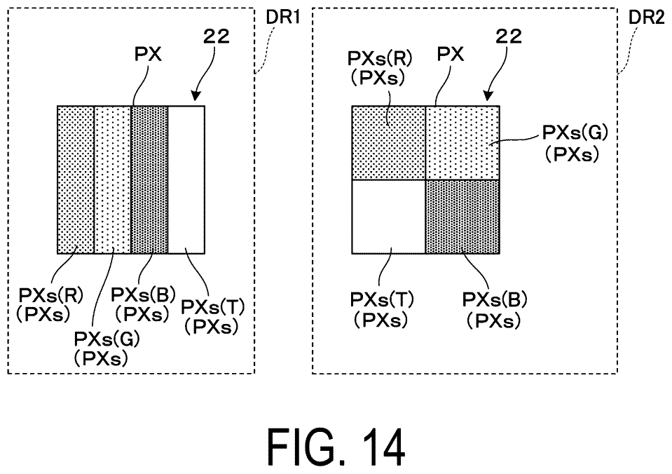

The array of sub-pixels PXs in a pixel PX will be described with reference to FIG. 14. In FIG. 14, the first region DR1 illustrates one example of an array of sub-pixels PXs, and the second region DR2 illustrates another example of an array of sub-pixels PXs. Four types of sub-pixels PXs(R), PXs(G), PXs(B), and PXs(T) are arrayed in a uniform stripe pattern. However, these sub-pixels may be arrayed in a Bayer pattern.

In the image observation period illustrated in FIG. 12, all the light-emitting elements 10r, 10g, and 10b that constitute the light source 10 are caused to emit light, thereby supplying the light-guiding member 21 with the white illumination light ILr, ILg, ILb. The illumination light ILr, ILg, ILb is scattered at the scattering region 12b of the scattering member 12, and is emitted from the light-guiding member 21. The second polarized light P2 of the illumination light ILr, ILg, ILb passes through the first polarizing plate 15 of the transmissive-type liquid crystal panel 22, and illuminates the sub-pixels PXs(R), PXs(G), PXs(B), and PXs(T) that constitute each of the pixels PX. Thus, the ML(R), the ML(G), and the ML(B) of the first polarized light P1 that have been modulated are outputted in parallel from the transmissive-type liquid crystal panel 22. However, the sub-pixel PXs(T) is in the OFF state, and does not transmit the illumination light. The image light ML(R), ML(G), ML(B) outputted from each of the sub-pixels PXs(R), PXs(G), and PXs(B) of the transmissive-type liquid crystal panel 22 enters the switching half-wave plate 23 that is in the OFF state. The switching half-wave plate 23 transmits the image lights ML(R), ML(G), and ML(B) of the first polarized light P1 while its polarization direction is maintained as it is. The image lights ML(R), ML(G), and ML(B) of the first polarized light P1 that have passed through the switching half-wave plate 23 pass through the polarizing lens 50 functioning as a convex lens for the first polarized light P1 to form a virtual image.

In addition, in an outside-light observation period illustrated in FIG. 13, the light source 10 is turned into a non-emitting state to stop supplying the illumination light IL to the light-guiding member 21. The outside light OL enters the transmitting region 12a of the scattering member 12, and passes through the light-guiding plate 11. Thus, the outside light OL travels straight so as to intersect the light-guiding member 21, and enters the transmissive-type liquid crystal panel 22. At this time, the sub-pixels PXs(R), PXs(G), PXs(B), and PXs(T) that constitute each of the pixels PX of the transmissive-type liquid crystal panel 22 are driven, for example, in the maximum transmitting state. The second polarized light P2 of the outside light OL travels straight through the transmissive-type liquid crystal panel 22, that is, through the sub-pixels PXs(R), PXs(G), PXs(B), and PXs(T) to be converted into the first polarized light P1, and enters the switching half-wave plate 23. The switching half-wave plate 23 in the ON state rotates the polarization direction of the outside light OL of the first polarized light P1 by 90°, and outputs the light as the second polarized light P2. The outside light OL of the second polarized light P2 that has passed through the switching half-wave plate 23 passes through the polarizing lens 50 functioning as a parallel flat plate for the second polarized light P2, and enters the eye EY without receiving any image formation operation by the composite display member 20 and the polarizing lens 50.

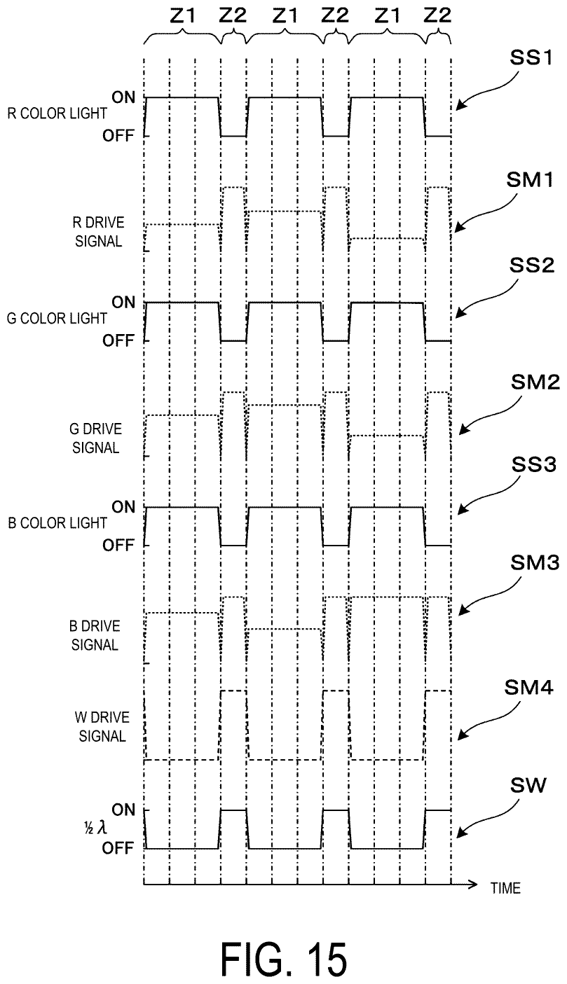

FIG. 15 is a timing chart used to describe the display operation of the first virtual-image display device 100A. In FIG. 15, a W drive signal SM4 for the sub-pixel PXs(T) is added to the drive signals similar to those in FIG. 11.

The first virtual-image display device 100A displays the image lights ML(R), ML(G), and ML(B) of three colors in parallel at the same time. In the present embodiment, in the second sub-frame Z2 for observing the outside light, the driving circuit 81 also outputs the W drive signal SM4 to the sub-pixel PXs(T) for the outside light OL, in addition to outputting of the drive signals SM1 to SM3 to the sub-pixels PXs(R), PXs(G), and PXs(B). When the first virtual-image display device 100A is in the outside-light observation period and the transmissive-type liquid crystal panel 22 is in the non-display state, the outside light OL passes through the sub-pixels PXs(R), PXs(G), and PXs(B) of the transmissive-type liquid crystal panel 22 in a well-balanced manner. Thus, it is possible to observe the colorless outside-world image. In addition, the outside light OL also passes through the sub-pixel PXs(T) of the transmissive-type liquid crystal panel 22, which makes it possible to further increase the brightness of the see-through image.

In the virtual-image display device 100A, 100B according to the fourth embodiment, the light source 10 generates white illumination light ILr, ILg, ILb, and the transmissive-type liquid crystal panel 22 includes the sub-pixel PXs(R) for red, the sub-pixel PXs(G) for green, and the sub-pixel PXs(B) for blue to perform modulation with the sub-pixels PXs(R), PXs(G), and PXs(B) for individual colors in accordance with the light emitted by the light source 10, and turns the colorless sub-pixel PXs(T) into the transmitting state when the light source 10 does not emit light. In this case, in the first sub-frame Z1 that is the sub-frame for observing an image, it is possible to display the red image light ML(R), the green image light ML(G), and the blue image light ML(B) at the same time. In addition, in the second sub-frame Z2 that is the sub-frame for observing the outside light, by operating at least the colorless sub-pixel PXs(T), it is possible to observe the color image and the see-through image in a time-division manner.

### Modification Examples and Others

These are descriptions of the present disclosure with reference to the embodiments. However, the present disclosure is not limited to the embodiments described above. It is possible to implement the present disclosure in various modes without departing from the spirit of the disclosure. For example, the following modifications are possible.

Although, in the scattering member 12, the scattering region 12b entirely surrounds the transmitting region 12a, the scattering region 12b may not entirely surround the transmitting region 12a. Furthermore, it is possible to change the arrangement of the transmitting region 12a and the scattering region 12b or the like on an as-necessary basis.

The scattering member 12 may not be a member obtained by processing the front surface of the light-guiding plate 11. The scattering member 12 may be obtained by attaching, to the front surface of the light-guiding plate 11, a sheet-shaped member in which the transmitting region 12a and the scattering region 12b are formed, for example.

The scattering member 12 may be provided at both surfaces 11a and 11b of the light-guiding plate 11.

The liquid crystal lens serving as the polarizing lens 50 is not limited to that including a ring zone section RA having a ring shape. For the polarizing lens 50, it may be possible to employ various types of structures having a lens function for certain polarized light.

In the description above, it is assumed that the HMD 200 is mounted on the head, and is used. However, the virtual-image display device 100A, 100B described above can be used as a hand-held display that is not worn on the head and is to be looked into like binoculars. In other words, in the present disclosure, the head-mounted display includes a hand-held display.

A virtual-image display device according to a specific aspect includes, in the order from the outside world: a light-guiding member configured to cause illumination light from a light source to propagate; a scattering member included in the light-guiding member and including a transmitting region and a scattering region; a transmissive-type liquid crystal panel configured to turn into a displaying state and a non-display state; a switching half-wave plate configured to switch a polarization direction of incident light into a first direction and a second direction, the first direction and the second direction intersecting each other; and a polarizing lens having refractive power that causes polarized light having the first direction to be imaged as a virtual image and configured to transmit polarized light having the second direction, in which the transmitting region is disposed at a position that is opposed to one of a pixel and a sub-pixel of the transmissive-type liquid crystal panel, and the switching half-wave plate causes image light to enter the polarizing lens as the polarized light having the first direction when in the displaying state, and causes outside light to enter the polarizing lens as the polarized light having the second direction when in the non-displaying state.

In the virtual-image display device, when the transmissive-type liquid crystal panel is in the displaying state, the switching half-wave plate causes the image light from the transmissive-type liquid crystal panel to enter the polarizing lens as the polarized light having the first direction. In addition, when the transmissive-type liquid crystal panel is in the non-displaying state, the switching half-wave plate causes the outside light that has passed through the transmissive-type liquid crystal panel to enter the polarizing lens the polarizing lens having the second direction. Thus, it is possible to switch the image light and the outside light and observe them in parallel. In other words, by utilizing the scattering member, it is possible to use the transmissive-type liquid crystal panel to observe the image as well as to observe the outside world, and it is possible to suppress a deterioration in the see-through transmittance while securing the brightness of display.

In the virtual-image display device according to the specific aspect, the transmitting region transmits the outside light, and the scattering region scatters the illumination light.

In the virtual-image display device according to the specific aspect, the scattering region is disposed around the transmitting region. In this case, it is possible to cause more illumination light to enter the transmissive-type liquid crystal panel.

In the virtual-image display device according to the specific aspect, the scattering region has a nano-structure configured to control a scattering direction and a scattering angle of the illumination light. In this case, it is possible to efficiently cause the illumination light to enter the transmissive-type liquid crystal panel.

In the virtual-image display device according to the specific aspect, the scattering member is disposed at a surface of a light-guiding plate included in the light-guiding member, this surface being at an opposite side from the transmissive-type liquid crystal panel. In this case, it is possible to make the output angle of the scattering light gentle, which makes it easy to control the scattering angle while making the fabrication of the scattering member easy.

In the virtual-image display device according to the specific aspect, the scattering member is disposed at a surface of a light-guiding plate included in the light-guiding member, this surface being opposed to the transmissive-type liquid crystal panel. In this case, it is possible to concentrate the scattering light on a relatively very small region.

In the virtual-image display device according to the specific aspect, the light source switches and generates illumination light of red, illumination light of green, and illumination light of blue, the transmissive-type liquid crystal panel includes a colorless pixel, and performs modulation with the pixel in accordance with the color of illumination light generated by the light source, and the transmissive-type liquid crystal panel turns the pixel into a transmitting state when the light source does not emit light. In this case, during the sub-frame for observing an image, there are display sections for individual colors in which image lights of red, green, and blue are displayed.

In the virtual-image display device according to the specific aspect, the light source generates white illumination light, the transmissive-type liquid crystal panel includes a sub-pixel for red, a sub-pixel for green, and a sub-pixel for blue, and performs modulation with the sub-pixel for each of the colors in accordance with the light emitted by the light source, and the transmissive-type liquid crystal panel turns the sub-pixel for each of the colors into a transmitting state when the light source does not emit light. In this case, during the sub-frame for observing an image, it is possible to display the red image light, the green image light, and the blue image light at the same time.

In the virtual-image display device according to the specific aspect, the light source generates white illumination light, the transmissive-type liquid crystal panel includes a sub-pixel for red, a sub-pixel for green, a sub-pixel for blue, and a colorless sub-pixel, and performs modulation with the sub-pixel for each of the colors in accordance with the light emitted by the light source, and the transmissive-type liquid crystal panel turns the colorless sub-pixel into a transmitting state when the light source does not emit light. In this case, during the sub-frame for observing an image, it is possible to display the red image light, the green image light, and the blue image light at the same time. In addition, during the sub-frame for observing the outside light, by operating at least the colorless sub-pixel, it is possible to observe the color image and the see-through image in a time-division manner.

In the virtual-image display device according to the specific aspect, the transmissive-type liquid crystal panel turns the sub-pixel for each of the colors into a transmitting state when the light source does not emit light. In this case, during the sub-frame for observing the outside light, it is possible to utilize the sub-pixel for each of the color, and it is possible to increase the brightness of the see-through image.

In the virtual-image display device according to the specific aspect, the colorless sub-pixel together with the sub-pixel for each of the colors is arrayed in a stripe pattern or a Bayer pattern to constitute a pixel.

In the virtual-image display device according to the specific aspect, in the displaying state, the scattering member causes the illumination light that passes through the scattering region to enter to form image light, and in the non-display state, the scattering member transmits the outside light that has passed through the transmitting region.

In the virtual-image display device according to the specific aspect, the transmissive-type liquid crystal panel includes a liquid-crystal modulation member, and a pair of polarizing plates between which the liquid-crystal modulation member is interposed. The polarization directions of the pair of polarizing plates are set to intersect or set to be parallel, depending on a property of or a driving method of the liquid-crystal modulation member.

The virtual-image display device according to the specific aspect further includes a driving circuit configured to operate the light source, the transmissive-type liquid crystal panel, and the switching half-wave plate in a synchronized manner.

What is claimed is:

1. A virtual-image display device comprising, in an order from an outside world:
a light-guiding member configured to cause illumination light from a light source to propagate;
a scattering member included in the light-guiding member and including a transmitting region and a scattering region;
a transmissive-type liquid crystal panel configured to turn into a displaying state and a non-display state;
a switching half-wave plate configured to switch a polarization direction of incident light into a first direction and a second direction, the first direction and the second direction intersecting each other; and
a polarizing lens having refractive power that causes polarized light having the first direction to be imaged as a virtual image and configured to transmit polarized light having the second direction, wherein
the transmitting region is disposed at a position that is opposed to one of a pixel and a sub-pixel of the transmissive-type liquid crystal panel, and
the switching half-wave plate causes image light to enter the polarizing lens as the polarized light having the first direction when in the displaying state, and causes outside light to enter the polarizing lens as the polarized light having the second direction when in the non-displaying state.

2. The virtual-image display device according to claim 1, wherein
the transmitting region transmits the outside light, and
the scattering region scatters the illumination light.

3. The virtual-image display device according to claim 1, wherein
the scattering region is disposed around the transmitting region.

4. The virtual-image display device according to claim 1, wherein
the scattering region has a nano-structure configured to control a scattering direction and a scattering angle of the illumination light.

5. The virtual-image display device according to claim 1, wherein
the scattering member is disposed at a surface of a light-guiding plate included in the light-guiding member, this surface being at an opposite side from the transmissive-type liquid crystal panel.

6. The virtual-image display device according to claim 1, wherein
the scattering member is disposed at a surface of a light-guiding plate included in the light-guiding member, this surface being opposed to the transmissive-type liquid crystal panel.

7. The virtual-image display device according to claim 1, wherein
the light source switches and generates illumination light of red, illumination light of green, and illumination light of blue,
the transmissive-type liquid crystal panel includes a colorless pixel, and performs modulation with the pixel in accordance with the color of illumination light generated by the light source, and
the transmissive-type liquid crystal panel turns the pixel into a transmitting state when the light source does not emit light.

8. The virtual-image display device according to claim 1, wherein
the light source generates white illumination light,
the transmissive-type liquid crystal panel includes a sub-pixel for red, a sub-pixel for green, and a sub-pixel for blue, and performs modulation with the sub-pixel for each of the colors in accordance with the light emitted by the light source, and
the transmissive-type liquid crystal panel turns the sub-pixel for each of the colors into a transmitting state when the light source does not emit light.

9. The virtual-image display device according to claim 1, wherein
the light source generates white illumination light,
the transmissive-type liquid crystal panel includes a sub-pixel for red, a sub-pixel for green, a sub-pixel for blue, and a colorless sub-pixel, and performs modulation with the sub-pixel for each of the colors in accordance with the light emitted by the light source, and
the transmissive-type liquid crystal panel turns the colorless sub-pixel into a transmitting state when the light source does not emit light.

10. The virtual-image display device according to claim 9, wherein
the transmissive-type liquid crystal panel turns the sub-pixel for each of the colors into a transmitting state when the light source emits light.

11. The virtual-image display device according to claim 8, wherein
the colorless sub-pixel together with the sub-pixel for each of the colors is arrayed in a stripe pattern or a Bayer pattern to constitute a pixel.

12. The virtual-image display device according to claim 1, wherein
in the displaying state, the scattering member causes the illumination light that passes through the scattering region to enter to form the image light, and
in the non-display state, the scattering member transmits the outside light that passed through the transmitting region.

13. The virtual-image display device according to claim 1, wherein
the transmissive-type liquid crystal panel includes a liquid-crystal modulation member, and a pair of polarizing plates between which the liquid-crystal modulation member is interposed.

14. The virtual-image display device according to claim 1, further comprising:
a driving circuit configured to operate the light source, the transmissive-type liquid crystal panel, and the switching half-wave plate in a synchronized manner.
